(19) United States
(12) Patent Application Publication
(10) Pub. No.: US 2005/0042380 A1
(43) Pub. Date: Feb. 24, 2005

(54) Basic suspension, its preparation and process for paper deacidification

(76) Inventors: Piero Baglioni, Fiesole (IT); Luigi Dei, Firenze (IT); Rodorigo Giorgi, Prato (IT); Clauduis Vinicuis Schettino, Florence (IT)

Correspondence Address: Eitan Pearl;Latzer & Cohen Zedek, Suite 1001, 10 Rockefeller Plaza, New York, NY, 10020, US

(21) Appl. No.: 10/501,511

(22) PCT Filed: Jan. 15, 2002
(86) PCT No.: PCT/EP02/00319

(51) Int. Cl. B05D 5/00; B05D 1/02; B05D 1/18; B05D 1/40; B01F 3/12

(52) U.S. Cl. 427/399; 427/421.1; 427/430.1; 427/429; 516/88

(57) ABSTRACT

Basic suspension wherein oxides hydroxides, carbonates, or their mixture, in the form of particles having determined dimensions are suspended in the appropriated solvents, are described. Processes for the preparation of the above said suspensions and of the suspended particles are also described together with the uses of the suspensions in processes for paper deacidification and/or porous materials consolidation.

### FIELD OF THE INVENTION

The present inventions refers to basic suspensions which, thanks to their physico-chemical properties, can annul the acidity present in papers, which depends on the paper production processes, on the environment pollution, and on the usage of acid inks as, for example, in the modern books.

### STATE OF THE ART

It is well known how the presence of acidity in paper is the main responsible of its degradation with consequent loss of a lot of important information and in particular of historically important documents.

The acidity, which is present particularly in modem paper, forms during the paper manufacture, it is also a consequence of the use of acid inks (which are very common especially in the last centuries) or because of the adsorption of acid pollutants which are present in the air.

Many different techniques and products have been studied or developed in order to eliminate acidity from paper and published documents (paper de-acidification). Unfortunately, up to now, the problem is far to be satisfactorily solved, and the specialists are intensively looking for new products capable of annulling the acidity present in paper.

Calcium, magnesium, and barium hydroxide aqueous solutions have been widely used for many decades, but, unfortunately, they had often induced not desirable side effects, because of their strong alkaline conditions, with subsequent depolymerization of cellulose.

Non aqueous deacidification processes have also been proposed. In Smith R. D., Mass Deacidification at the Public Archives of Canada in Conservation of Library and Archive Materials and the Graphic Arts, Butterworth Ed., London, 1987 the use of magnesium alkoxide deacidification solutions (Wei T'o method) is described; another method widely used is the Bookkeeper method which is based on the application of suspended Mgo that, subsequently converted in magnesium hydroxide, forms the alkaline reservoir. Unfortunately, these methods use chlorofluorocarbon (CFC) solvents. Alternatively, some solvent mixtures have been recently experimented, as thrielyne (90%) and methanol, but all of them are harmful.

Despite of its scarce usage, calcium hydroxide is an excellent deacidifying agent. Calcium hydroxide is physico-chemically friendly to most of papers and, once converted to calcium carbonate, works efficiently as alkaline reservoir. In IT 1.286.868 (in the name of the same Applicant) it is reported that suspensions of calcium hydroxide could be used to consolidate mural paintings and to deacidify paper. However, the calcium hydroxide suspensions in organic solvent described in this document were obtained from lime and the particle size distribution was quite broad and larger than several micrometers. Smaller particles were around 0.5 microns, 80% were greater than 1 micron. This originated two problems: firstly, kinetic stability was good but not excellent for some application procedures, for example spraying; secondly, because of particle sizes, a white glaze (or spots) on the treated surfaces could form.

Large calcium hydroxide particles showed a poor adhesions and penetrability into the cellulosic fibres.

Deacidifying agents must ensure good adhesion with fibres, so that the alkaline reservoir acts efficiently. Therefore, according to physico-chemical features of cellulose, particles with a surface charge density are preferred. Both these requirements are ensured by the use of particles smaller than micron size.

### SUMMARY OF THE INVENTION

The present invention refers to basic suspension wherein the suspended particles have determined dimensions, moreover the invention refers to process for the preparation of the suspensions and of the suspended particles and to the use of the suspension in processes of paper deacidification and porous materials consolidation.

### DETAILED DESCRIPTION OF THE INVENTION

The present invention makes it available basic suspension which allow the overcoming of the problems connected with paper acidity.

The suspension according to the inventions are preferably suspensions of basic oxides or hydroxides (which are capable of forming carbonates when in contact with the CO₂ of the air or to form, once adsorbed on the treated material, a reservoir of basicity stable for long periods of time) or basic carbonates or their mixture.

Particularly preferred according to the invention are the oxides, hydroxides or carbonates of alkali or earth-alkali metals or also other analogous compounds having basic properties.

Examples of compounds suitable for the suspensions according to the invention are: Li₂O, Na₂O, K₂O, MgO, CaO, SnO, SnO₂, PbO, Pb₂O Pb₂O₃, BiO, Bi₂O₃, Sb₂O₃, LiOH, NaOH, KOH, Mg(OH)₂, Ca(OH)₂, Al(OH)₃, Sn(OH)₂, Sn(OH)₄, Pb(OH)₂, Bi(OH)₃, Sb(OH), Li₂CO₃, Na₂CO₃ decahydro, Na₂CO₃, K₂CO₃, MgCO₃, CaCO₃, PbCO₃, anhydro and basic, Bi₂O₂CO₃ or their mixtures.

Particularly preferred according to the invention are the suspensions of Mg(OH)₂, Ca(OH)₂, Sn(OH)₂.

The preferred suspending solvents are chosen in the group consisting of: water, ethyl ether, acetone, alcohols, and their mixtures.

Among the alcohols particularly preferred are: methanol, ethanol, 1-propanol, 2-propanol, butanol, pentanol, and their mixtures.

Particularly preferred are suspension of the Ca(OH)₂ hydroxide in 1% (w/w) in water and 99% in 1-propanol (or 2-propanol).

The dimensions of the hydroxide particles in suspension play also a crucial role in the suspensions according to the invention. In fact, such particles must be capable of entering the fibres of the materials to treat, linking with them, without covering effect over the written test since this would produce a not desirable aesthetically effect. Large particles need longer time to penetrate in depth, but the fast volatillsation of used organic solvents does not usually allow it. Therefore, a strict control of particle size is essential before the application.

Particularly preferred are suspensions according to the invention wherein the suspended particles have dimension comprised between 10 nm up to 21 μm, more preferably between 50 nm up to 500 nm.

The suspensions according to the invention have a concentration of suspended particles in the solvent preferably comprised between: 0.1-50 g/L more preferably between 1-25 g/L.

Especially preferred is a concentration of: 10 g/L.

The suspensions according to the invention can be obtained by vigorous stirring of the particles to be suspended in the appropriate solvent (or solvents mixture), if necessary with the aid of a sonicator or ultra-sonicator or with the aid of a homogeniser.

The particles to be suspended, having the desired measures, can be obtained by high temperature homogeneous phase reaction, heterogeneous phase reaction (slaking of oxides), and by mixing two water in oil microemulsion obtaining a low solubility salt in nanosized aqueous core.

The first process consists in reacting solutions of the appropriate reagents (for example a solution of an hydroxide as NaOH and a solution of a chloride as CaCl₂) at high temperature (about 90° C.) under stirring.

The solutions to be reacted can be obtained by solving the reagents in a solvent chosen in the group consisting of: water, a solution of diols or a mixture water/diols (the reagents can be solved both in the same or each one in a different solvent 15′ chosen from the above said group).

The preferred diols are C₁alkane diols as, for example, 1,2 ethandiol or 1,2 propandiol.

The suspension obtained after reaction at high temperature and containing the formed particles is cooled down to room temperature under N₂, the supernatant solution is eliminated and the suspension is washed to eliminate secondary reaction products and concentrated in vacuum to form a paste which can be suspended again in the desired solvent amount.

According to the slaking of oxides process the oxide is slaked in pure water, the obtained hydroxide paste is mixed with an alcohol under vigorous stirring and sonicated or homogenised.

Alternatively, according to known techniques, two water in oil microemulsions are prepared wherein the aqueous phase containing salts, when the two microemulsions are mixed precipitation takes place wherein the nanosized dimensions of the aqueous drops impose limited growth of particles.

Given the above said, examples of suspensions according to the invention are reported hereinafter in order to better illustrate the invention:

### EXAMPLE 1

Calcium hydroxide micro-particles have been obtained by slaking CaO powder in pure water, at room temperature:

| | |
|---|---|
| CaO powder | 10 g |
| Water | 30 g |

Successively, suspensions have been prepared by mixing the calcium hydroxide paste with alcohol, under vigorous stirring, and have been sonicated for 30 minutes with an ultra-sonicator for further reducing the particle size and obtaining a complete dispersion of the calcium hydroxide agglomerates. A homogeniser system, for preparation of some hydroxide dispersions, can also be used.

### EXAMPLE 2

Calcium hydroxide micro-particles have been obtained by slaking CaO powder in water/alcohol mixtures, according to the following proportions:

| | | |
|---|---|---|
| CaO powder | 1 | g |
| Water | 5 | g |
| 1-propanol | 25 | mL |

The metal oxide/water/alcohol mixture, after 30 minutes of sonication or vigorous stirring has been left to rest at least B hours. Suspensions have been prepared by mixing the calcium hydroxide paste, after filtration, with alcohol, under vigorous stirring. Suspensions have been sonicated for 30 minutes with an ultra-sonicator for further reducing the particle size and obtaining a complete dispersion of the calcium hydroxide agglomerates. A homogeniser system, for preparation of some hydroxide dispersions, was also necessary.

### EXAMPLE 3

Calcium hydroxide nanoparticles, from homogeneous phase reaction, have been achieved by mixing a NaOH aqueous solution with a CaCl₂ aqueous solution. They were previously heated up to a selected temperature (around 90° C.), under continuous stirring and keeping the temperature of the mixture constant within ±1° C.; the supersaturating degree was kept in the range 2-10. Aqueous Ca(OH)₂ suspension was allowed gradually reaching the room temperature under a nitrogen atmosphere to avoid the M(OH)₂ carbonation. The supernatant solution was discarded and the remaining suspension was washed five times with water to reduce the NaCl concentration below. 10⁻⁶ M. Each time, the dilution ratio between the concentrated suspension and the washing solution was about 1:10. The complete removal of NaCl from the suspension was controlled by the AgNO₃ test. The suspension was then concentrated in vacuum at 40° C. up to a weight ratio M(OH)₂/water of 0.8, that is the same of the standard slaked lime paste. Dispersions have been prepared by mixing 10 g of the calcium hydroxide paste with 1 L of alcohol, under vigorous stirring, and/or by using a homogeniser.

### EXAMPLE 4

Calcium hydroxide nanoparticles, from homogeneous phase reaction, have been obtained by mixing a NaOH aqueous solution with a CaCl₂ diol solution (i.e. 1,2 ethandiol or 1,2 propandiol). Diol solution was previously heated up to a selected temperature (around 150° C.), under continuous stirring and keeping the temperature of the mixture constant within ±1° C.; the supersaturating degree was in the range 2-10. The NaOH aqueous solution was added dropwise to dial solution keeping the temperature around 150° C. The Ca(OH)₂ water/diol suspension was allowed gradually reaching the room temperature under a nitrogen atmosphere to avoid the M(OH)₂ carbonation. The supernatant solution was discarded and the remaining suspension was washed five times with water to reduce the NaCl concentration below 10⁻⁶ M. Each time, the dilution ratio between the concentrated suspension and the washing solution was about 1:10. The complete removal of NaCl from the suspension was controlled by the AgNO₃ test. Then, water/diol suspension was washed several times with 2-propanol to remove diol solvents. Successively, solutions were concentrated in vacuum at 40° C. up to a weight ratio M(OH)₂/water of 0.8, that is the same of the standard slaked lime paste. Dispersions have been prepared by mixing log of the calcium hydroxide paste with 1 L of alcohol, under vigorous stirring, and/or by using a homogeniser.

### EXAMPLE 5

Two water in oil microemulsions have been obtained.

C₁₂E₄ surfactant solutions in cyclohexane have been prepared and used as oil phase in the microemulsion. These solutions have been mixed with NaOH (0.1M) and CaCl₂ (0.05M) aqueous solution.

Microemulsion (water in oil) composition is:

| | | |
|---|---|---|
| C₁₂E₄ | 0.15 | g (0.2 M) |
| Cyclohexane | 1.15 | g |
| NaOH (0.1M) and CaCl₂ (0.05M) aqueous solution | 25 | μL (w = 2) |

Water/surfactants molar ratio ranging (molar ratio w=water/surfactant) from 1 to 5. Aqueous solution was added to oil phase/surfactant solution by a microsyringe. The preparation was held at 15° C. Similar isotropic, transparent, and stable systems, were obtained in a wider temperature range, 15-25° C. Microemulsions have been equilibrated at 15° C. for 10 days. Crystalization processes took place within the confined volume of the microdroplets. Synthesized particles, after filtration, washing, and drying have been dispersed in nonaqueous solvents, by vigorous stirring and/or with the aid of a homogeniser.

### EXAMPLE 6

Solution of Igepal CO 520 in cyclohexane (0.15M) has been prepared and mixed, respectively, with an aqueous solution of NaOH (0.5M) and with an aqueous solution of CaCl₂ (0.25M).

Microemulsion (water in oil) composition is:

| | | |
|---|---|---|
| Igepal CO 520 solution (0.15M) | 1 | g |
| NaOH (0.5M) and CaCl₂ (0.25M)aqueous solution | 25 | μL (w = 2) |

Water/surfactants molar ratio ranging (molar ratio w=water/surfactant) from 1 to 11.

Aqueous solution was added to oil phase/surfactant solution by a microsyringe. The preparation was held at environmental (25° C.). Analogous systems, isotropic, transparent, and stable was obtained in a wider temperature range, 15-25° C. Microemulsions have been equilibrated at 25° C. for a week.

Synthesized particles, after filtration, washing, and drying have been dispersed in nonaqueous solvents, by vigorous stirring and/or with the aid of a homogeniser.

Procedures for Application

The physicochemical properties of the prepared dispersions make them very attractive for different application procedures in paper deacidificatio processes, such as:
spraying,
immersing,
brushing,
mass-deacidification process.

Small particle dimensions allows using a sprayer without risks of hole occlusion. The spraying method is preferred.

The complete immersion of paper sheet is possible also for longer period. Aqueous deacidification methods, because of the strong aggressive effect of high pH, do not allow a long contact with paper sheet, commonly up to 20 minutes. This produces only a poor deacidification effect.

Moreover the basic suspensions according to the invention can be used also for the consolidation of porous materials as for example stones, plasters building materials and similar.

1) (Cancelled)

2) (Cancelled)

3) (Cancelled)

4) (Cancelled)

5) (Cancelled)

6) (Cancelled)

7) (Cancelled)

8) (Cancelled)

9) (Cancelled)

10) (Cancelled)

11) (Cancelled)

12) Basic suspension wherein the suspended particles have dimensions comprised between 10 nm up to 2 μm.

13) Basic suspensions according to claim 12 wherein the suspended particles have dimensions comprised between 50 nm up to 500 nm.

14) Basic suspensions according to claim 12 wherein the suspended particles are basic oxides or hydroxides or carbonates or their mixture.

15) Basic suspensions according to claim 14 wherein the suspended basic oxides are chosen in the group consisting of: Li₂O, Na₂O, K₂O, MgO, CaO, SnO, SnO₂, PbO, Pb₂O Pb₂O₃, BiO, Bi₂O₃, Sb₂O₃ or their mixtures.

16) Basic suspensions according to claim 14 wherein the suspended basic hydroxides are chosen in the group consisting of: LiOH, NaOH, KOH, Mg(OH)₂, Ca(OH)₂, Al(OH)₃, Sn(OH)₂, Sn(OH)₄, Pb(OH)₂, Bi(OH)₃, Sb(OH)₃ or their mixtures.

17) Basic suspensions according to claim 14 wherein the suspended basic carbonates are chosen in the group consisting of: Li₂CO₃, Na₂CO₃ deca-hydro, Na₂CO₃, K₂CO₃, MgCO₃, CaCO₃, PbCO₃, anhydro and basic, Bi₂O₂CO₃ or their mixtures.

18) Basic suspensions according to claim 12 wherein the solvents are chosen in the group consisting of: water, ethyl ether, acetone and alcohols and their mixtures.

19) Basic suspension according to claim 18 wherein the alcohols are chosen in the group consisting of: methanol, ethanol, 1-propanol, 2-propanol, butanol, pentanol, and their mixtures.

20) Basic suspension according to claim 12 consisting of: Ca(OH)₂ hydroxide particles suspended in 1% water and 99% 1-propanol or 2-propanol (w/w).

21) Process for the preparation of the suspensions according to claim 11 by vigorous stirring of the particles to be suspended in the appropriate solvent (or solvents mixture), if necessary with the aid of a sonicator or ultra-sonicator or with the aid of a homogeniser.

22) Process according to claim 21 wherein the particles to be suspended are obtained by high temperature homogeneous phase reaction.

23) Process according to claim 21 wherein the particles to be suspended are obtained by slaking of the oxides.

24) Process according to claim 21 wherein the particles to be suspended are obtained by mixing two water in oil microemulsions, giving a low solubility salt in nanosized aqueous core.

25) Process for paper deacidification wherein suspensions according to claim 12 are applied to the papers to be deacidified by: spraying, immersing, brushing, or by mass-deacidification process.

26) Processes for the consolidation of porous materials wherein suspensions according to claim 12 are applied to said porous materials.
